(19) United States
(12) Patent Application Publication
(10) Pub. No.: US 2010/0212287 A1
(43) Pub. Date: Aug. 26, 2010

(54) THRUST REVERSER WITH A SYSTEM FOR BRAKING THE ACTUATORS

(75) Inventor: Benoit Kubiak, Saint Romain de Colbosc (FR)

Correspondence Address: CANTOR COLBURN, LLP, 20 Church Street, 22nd Floor, Hartford, CT, 06103, US

(73) Assignee: AIRCELLE, Gonfreville l'Orcher (FR)

(21) Appl. No.: 12/674,104

(22) PCT Filed: Jun. 18, 2008
(86) PCT No.: PCT/FR2008/000845

§ 371 Date: Feb. 18, 2010

(30) Foreign Application Priority Data
Aug. 20, 2007 (FR) 0705901

(51) Int. Cl. F02K 1/72; F02K 1/76

(52) U.S. Cl. 60/226.2

(57) ABSTRACT

The present invention relates to a thrust reverser for a jet engine nacelle comprising at least one movable cowl (2) mounted on a fixed reverser structure between a closed position, in which they provide the nacelle with aerodynamic continuity and deactivate means for deflecting at least part of the air flow, and an open position in which they open a passage in the nacelle and activate said deflection means, each movable cowl being able to be moved between these two positions by at least one actuating means (6a, 6b), characterized in that the actuating means are combined with at least one means (10) for mechanically braking said actuating means.

### TECHNICAL FIELD

The present invention relates to a cascade-type thrust reverser for a jet engine nacelle.

### BACKGROUND

The role of a thrust reverser when an airplane is coming into land is to improve the ability of an airplane to brake by redirecting forward at least some of the thrust generated by the jet engine. During this phase, the reverser blocks off the gas jet pipe nozzle and directs the flow ejected from the engine toward the front of the nacelle, thereby generating a reverse thrust which adds to the braking of the airplane wheels.

The means employed to achieve this reorientation of the flow vary according to the type of reverser. However, in all cases, the structure of a reverser comprises moving cowls that can be moved between, on the one hand, a deployed position in which they open up within the nacelle a passage intended for the deflected flow and, on the other hand, a retracted position in which they close off this passage. These moving cowls may also perform a deflecting function or may simply activate other deflecting means.

In cascade-type thrust reversers, for example, the moving cowls slide along rails so that, by moving back during the opening phase, they uncover cascades of deflection vanes located within the thickness of the nacelle. A system of link rods connects this moving cowl to blocking doors which deploy into the ejection duct and block the exit as a direct flow. In door-type reversers on the other hand, each moving cowl pivots so that it blocks the flow and deflects it and therefore takes an active part in this reorientation.

In general, these moving cowls are actuated by pneumatically or electrically operated hydraulic or mechanical actuating cylinders.

For obvious safety reasons, these actuating cylinders have to be equipped with latches intended to keep them in the retracted position and prevent any accidental deployment of a moving cowl of the thrust reverser.

A distinction is generally drawn between two types of latch, known respectively as primary latches, mounted in pairs, and tertiary latches.

The two primary latches keep each moving cowl in the nominal retracted position and react the loads aimed at causing the translational movement of said moving cowl. These latches are redundant in order to cover any possible failure of one of the primary latches, each latch being engineered to be able to react in its entirety the sum of the loads aimed at causing the translational movement of the moving cowl.

The function of the tertiary latch is that of a back-up locking system which is called upon to react the loads aimed at causing the translational movement of the moving cowl only in the event of both primary latches failing.

These latches are generally actuated by a control signal, the emission of which forms part of the thrust reverser opening procedure. They therefore require their own electric power supply.

These locking systems also comply with strict safety standards, particularly following the Lauda Air accident in which the unwanted opening of the thrust reversal system during flight was found to have caused the loss of the airplane.

These latches are components that are important for flight safety and there is still a need for latching systems that are at once reliable, strong, lightweight and simple.

As explained previously, the thrust reversal systems are fitted with three lines of defense against unlatching, each with their own controls. The aerodynamic loads encountered during flight lead to latch fatigue and, what is more, thrust is also exerted on the latches on the ground during maintenance operations when these latches have to be unlocked by hand.

Electrically controlled thrust reverser systems are fitted with helical connecting actuators, for example of the “ball-screw” type, and are actuated by electric motors directly engaged with the actuator or engaged via mechanical transmission cables. These rotary power transmission devices give rise to inertial loadings which are key factors in the integrity of the actuator end stops and the structure of the reverser and entail the use of strategies to decelerate the electric control in the end-of-travel regions.

### BRIEF SUMMARY

The disclosure provides a thrust reversal system which on the whole is more reliable and less subject to premature wear of some of its mechanical component parts.

In order to do this, the invention relates to a thrust reverser for a jet engine nacelle comprising at least one moving cowl mounted on a reverser fixed structure between a closed position in which they ensure the aerodynamic continuity of the nacelle and deactivate means of deflecting at least part of the air flow, and an open position in which they open a passage in the nacelle and activate said deflection means, each moving cowl being able to be moved between these two positions by at least one actuating means, characterized in that the actuating means are associated with at least one means of mechanically braking said actuating means.

Thus, fitting means of mechanically braking the moving cowl actuating means makes it possible, on the one hand, to have an additional level of safety in the event of motor or electronics failure, and also makes it possible to have a system for retaining the actuating means which can then be lightly preloaded against the braking means.

This last feature makes it possible to introduce into the thrust reversal system a preload when the moving cowls are in the closed position.

In flight, this preload provides better absorption of vibrations and relative movements of the components in relation to one another, thus reducing mechanical fatigue thereof. Further, although it is not a latching system in the true sense, the braking means play an appreciable part in keeping the reverser in the closed position.

On the ground, during maintenance operations, this preload makes it possible to reduce the tensions applied on the means that latch the half-parts together, making these easier to unlatch and reducing fatigue wear thereon.

In the event of a motor or electronics failure during a reverser closing maneuver, the braking means may make it possible to stop the system and prevent the moving cowls from violently striking the ultimate end stops.

For preference, the actuating means are electric actuating means of the electric actuating cylinder type able to be driven by at least one associated electric motor.

Advantageously, the braking means are implemented at the electric motor.

Advantageously also, the braking means are arranged in such a way as to act at a drive shaft of the electric motor.

For preference, the actuating means are driven via flexible transmission shafts.

Alternatively or in addition, the braking means are positioned at the flexible transmission shafts.

More specifically, the brakes may be of the jaw type gripping the drive shaft on both sides.

According to a preferred embodiment of the invention, the reverser is a cascade-type reverser with vanes.

For preference, the braking means are associated with means of synchronizing them relative to one another.

Advantageously, the braking means are static braking means having a no-current engaged position.

Advantageously also, the braking means can be disengaged manually.

The present invention also relates to a nacelle for a jet engine, characterized in that it comprises at least one thrust reverser according to the invention.

### BRIEF DESCRIPTION OF THE DRAWINGS

The implementation of the invention will be better understood from the detailed description set out hereinbelow with reference to the attached drawing in which:

FIG. 1 is a perspective partial schematic view of a nacelle incorporating a cascade-type thrust reverser.

FIG. 2 is a schematic depiction of the moving cowls and of their actuating system.

FIG. 3 is a schematic depiction of the drive system of FIG. 2.

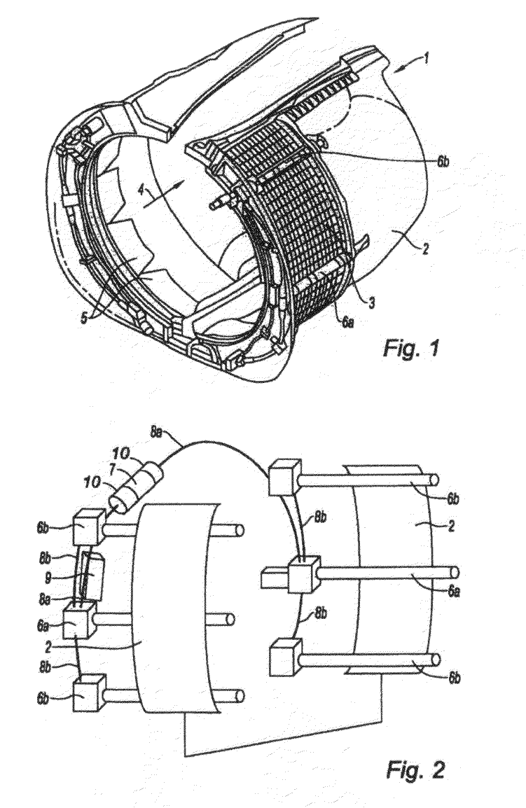

### DETAILED DESCRIPTION

Before an embodiment of the invention is described in detail, it is important to emphasize that the system described is not restricted to any particular type of reverser.

Although it has been illustrated in the form of an electrically actuated cascade-type reverser, it is of course possible to apply the principle of the invention to a pneumatically or hydraulically actuated system and to another type of reverser, for example of the doors type.

A cascade-type thrust reverser 1 generally comprises a structure comprising two semicircular moving cowls 2 able to slide along rails (not depicted) to uncover cascades of deflection vanes placed between the moving cowls 2 and a section through which the air flow that is to be deflected passes.

Blocking doors are positioned inside the structure so that they can pivot and move from a position in which they do not impede the passage of the air flow 4 into a position in which they block this passage. In order to coordinate the opening of the moving cowls 2 with an obstructing position of the blocking doors, these doors are mechanically connected to the moving cowl 2 by hinges and to the fixed structure by a system of link rods.

The movement of the moving cowls 2 along the rails along the outside of the structure is performed via a set of actuating cylinders 6a, 6b mounted on a front frame inside which there are housed an electric motor 7 and flexible transmission shafts 8a, 8b connected respectively to the actuating cylinders 6a, 6b in order to actuate these.

More specifically, each moving cowl 2 can be given a translational movement along its rails under the action of three actuating cylinders 6a, 6b, comprising a central actuating cylinder 6a and two additional actuating cylinders 6b, all actuated by a single electric motor 7 connected to a control interface 9. The power delivered by the electric motor 7 is first of all distributed to the central actuating cylinders 6a via two flexible transmission shafts 8a, then to the additional actuating cylinders 6b by flexible transmission shafts 8b.

In addition, each central actuating cylinder 6a that redistributes the movement to the additional actuating cylinders 6b is equipped with a manual control box 9 allowing the corresponding moving cowl 2 to be opened or closed manually during maintenance operations.

According to the invention, the means of driving the two moving cowls 2 are associated with braking means.

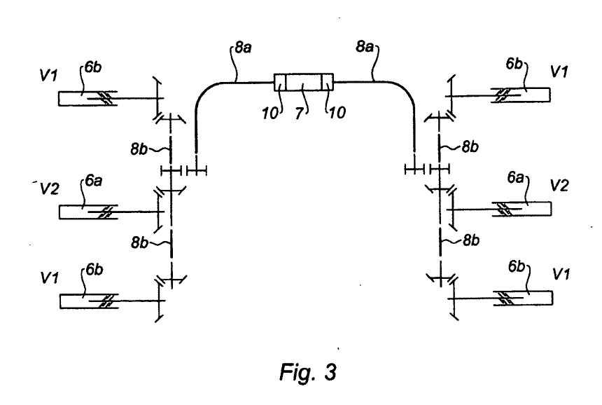

FIGS. 2 and 3 show brake blocks 10 positioned on each side of the motor 7 at a drive shaft for the right-hand cowl and at a drive shaft for the left-hand cowl.

The braking means used may, for example, be a no-current static brake using technology of the multiple disk brake type, returned by a spring and/or with electric unlocking control using an inbuilt linear actuator.

When the moving cowls 2 of the reverser are returned to the closed position against their respective end stop, the brake is released and preloads the flexible transmission line in order to avoid contact of the mechanical latches housed, for example, in the actuators 6a, 6b.

The braking means 10 will be made to unlock by one or more control units (not depicted) when thrust reversal is selected.

The static brake may be used to immobilize the moving cowls 2 in emergency situations and prevent dynamic impacts if end-of-travel control is lost.

When the latches are unlocked mechanically for maintenance purposes, the brake holds the moving cowls 2 on the end stops rather than on the lower latches. These latches can therefore be unlatched under no load, and therefore without any wear on said latches.

A mechanism is also installed for inhibiting the manually controlled brake. This mechanism may be a simple lever which counters the thrust of the springs, for example, and may thus release the disks. Actuation of this lever will allow the moving cowls 2 to be driven freely and then be secured in the desired position by re-engaging the brake.

Although the invention has been described in conjunction with particular exemplary embodiments, it is quite obvious that it is not in any way restricted thereto and that it encompasses all technical equivalents of the means described and combinations thereof where these fall within the scope of the invention.

1. A thrust reverser for a jet engine nacelle comprising:
at least one moving cowl mounted on a reverser fixed structure between a closed position in which they moving cowl ensures an aerodynamic continuity of the nacelle and deactivate means of deflecting at least part of an air flow, and an open position in which the moving cowl opens a passage in the nacelle and activate said deflection means, each moving cowl being able to be moved between these two positions by at least one actuating means,
wherein the actuating means are associated with at least one means of mechanically braking said actuating means.

2. The reverser as claimed in claim 1, wherein the actuating means are electric actuating means of the electric actuating cylinder type able to be driven by at least one associated electric motor.

3. The reverser as claimed in claim 2, wherein the braking means are implemented at the electric motor.

4. The reverser as claimed in claim 3, wherein the braking means are arranged in such a way as to act at a drive shaft of the electric motor.

5. The reverser as claimed in claim 2, wherein the actuating means are driven via flexible transmission shafts.

6. The reverser as claimed in claim 5, wherein the braking means are positioned at the flexible transmission shafts.

7. The reverser as claimed in claim 1, wherein the reverser is a cascade-type reverser with vanes.

8. The reverser as claimed in claim 1, wherein the braking means are associated with means of synchronizing the braking means relative to one another.

9. The reverser as claimed in claim 1, wherein the braking means are static braking means having a no-current engaged position.

10. The reverser as claimed in claim 1, wherein the braking means can be disengaged manually.
